(19) United States
(12) Patent Application Publication
(10) Pub. No.: US 2012/0111307 A1
(43) Pub. Date: May 10, 2012

(54) TANK VENTING DEVICE FOR A FUEL TANK OF A MOTOR VEHICLE

(75) Inventor: Harald Hagen, Creussen (DE)

(73) Assignee: Audi AG, Ingolstadt (DE)

(21) Appl. No.: 13/102,568

(22) Filed: May 6, 2011

(30) Foreign Application Priority Data
May 8, 2010 (DE) 10 2010 019 831.5

(51) Int. Cl. F02M 33/02; F02M 33/04

(52) U.S. Cl. 123/520

(57) ABSTRACT

A tank venting device for a fuel tank of a motor vehicle includes an activated carbon filter which is connected to a fuel tank via a first gas line and connected to the atmosphere or ambient environment via a second gas line. A valve unit includes a single two-stage solenoid valve to control a gas flow through the first and second gas lines.

### CROSS-REFERENCES TO RELATED APPLICATIONS

This application claims the priority of German Patent Application, Serial No. 10 2010 019 831.5, filed May 8, 2010, pursuant to 35 U.S.C. 119(a)-(d), the content of which is incorporated herein by reference in its entirety as if fully set forth herein.

### BACKGROUND OF THE INVENTION

The present invention relates to a tank venting device for a fuel tank of a motor vehicle.

The following discussion of related art is provided to assist the reader in understanding the advantages of the invention, and is not to be construed as an admission that this related art is prior art to this invention.

A fuel tank for a motor vehicle is usually provided with a tank venting device to prevent a buildup of an unwanted overpressure or unwanted low pressure inside the fuel tank when the ambient temperature rises or drops excessively as a result of condensation of fuel caused by a temperature rise or condensation of fuel vapors caused by a temperature drop. In addition, the tank venting device allows air displaced by fuel during refueling of the motor vehicle to escape from the interior of the fuel tank. To prevent an undesired a release of hydrocarbons into the atmosphere or environment, conventional tank venting devices include an activated carbon filter which is normally connected by a first gas line with the fuel tank, by a second gas line to the atmosphere or environment, and by a third gas line with an intake tract of the internal combustion engine. The first gas line vents the fuel tank and includes predominantly a tank shut-off valve which opens, when encountering a certain overpressure or low pressure in the fuel tank. When the tank shut-off valve is open, the second gas line provides a discharge into the atmosphere of air which has been liberated during refueling and/or flows out from the gas tank into the activated carbon filter and is freed there from hydrocarbons. Moreover, when the activated carbon filter is regenerated during operation of the internal combustion engine, air from the atmosphere is drawn through the second gas line, the activated carbon filter and the third gas line into the intake tract of the internal combustion engine to flush and thereby clear the activated carbon filter from adsorbed hydrocarbons and to feed the hydrocarbons together with the aspirated air into the combustion chambers of the internal combustion engine for combustion.

When operating a motor vehicle by an internal combustion engine or in the case of a hybrid vehicle which is alternately operated by an internal combustion engine and an electric motor, the activated carbon filter is normally regenerated as a result of the frequent operation of the internal combustion engine. In contrast thereto, in so-called plug-in motor vehicles with an electric motor as driving motor and an internal combustion engine used only as auxiliary motor for charging the vehicle battery, the electromotive operation is predominant. Thus, in these types of motor vehicles, an activated carbon filter possibly charged with a greater amount of hydrocarbons may not be regenerated over a lengthy period. At the location where the activated carbon filter communicates with the atmosphere via the second gas line, bleed emissions may be encountered which involve an escape of hydrocarbons from the activated carbon filter as a result of diffusion processes and their unwanted release into the atmosphere via the second gas line.

It would be desirable and advantageous to provide an improved tank venting device to obviate prior art shortcomings.

### SUMMARY OF THE INVENTION

According to one aspect of the present invention, a tank venting device for a fuel tank of a motor vehicle includes an activated carbon filter connected to a fuel tank via a first gas line and connected to the atmosphere or ambient environment via a second gas line, and a valve unit including a single two-stage solenoid valve which controls a gas flow through the first and second gas lines.

In accordance with the present invention, a tank venting device is realized which has a minimum of components and can easily be operated by using a single controllable solenoid valve which permits to simultaneously clear the gas flow through the first and second gas lines in the event both gas lines have to be opened, for example during refueling of the motor vehicle so as to route the gas flow, displaced from the fuel tank and charged with hydrocarbons, through the activated carbon filter for purging the hydrocarbons.

According to another advantageous feature of the present invention, the solenoid valve can include a single solenoid to actuate a first valve stage in the first gas line and a second valve stage in the second gas line. The single solenoid may include an armature which is fixedly connected with a valve member of the first valve stage and with a valve member of the second valve stage.

According to another advantageous feature of the present invention, the solenoid valve may be constructed as a proportional valve in which an opening cross section of the first and second valve stages is proportional to a current intensity of an excitation current of the solenoid. As an alternative, the solenoid valve may be constructed as a shut-off valve, with the first and second valve stages being switchable only between an open position and a closed position.

According to another advantageous feature of the present invention, the first and second valve stages of the solenoid valve may open, when current is supplied to the solenoid and spontaneously close when a supply of current is cut, or vice versa.

According to another advantageous feature of the present invention, the first and second valve stages of the solenoid valve may open, when current is supplied to the solenoid and remain open when a supply of current is cut until the supply of current to the solenoid has been reestablished. When the solenoid valve is constructed as a proportional valve, both valve stages suitably have defined opening cross sections in open position.

According to another advantageous feature of the present invention, at least two overflow valves can be switched in parallel, with one of the overflow valves constructed in the form of an overpressure protection valve and with the other one of the overflow valves constructed in the form of a low pressure protection valve. In this way, unwanted overpressure or low pressure in the fuel tank as a result of a severe temperature rise of temperature drop, respectively, can be prevented. The terms “overpressure” and “low pressure” relate hereby to atmospheric pressure. Thus, one of the overflow protection valves opens, when the pressure in the fuel tank exceeds an upper threshold value above atmospheric pressure, whereas the other one of the overflow protection valves opens, when the pressure in the fuel tank falls below a lower threshold value below atmospheric pressure. In this way, pressure compensation is attained in both cases by the first gas line, activated carbon filter, and second gas line, even when the solenoid valve is closed.

According to another advantageous feature of the present invention, the two overflow valves may be arranged in a bypass line which branches off the first gas line upstream of the first valve stage and feeds into the second gas line downstream of the second valve stage. By bypassing both valve stages with only two overflow valves, pressure compensation is rendered possible at all times. Of course, other configurations of both overflow valves are conceivable as well. For example, the two overflow valves may be arranged in a bypass line which branches off the first gas line upstream of the first valve stage and feeds back into the first gas line downstream of the first valve stage. The two overflow valves may also be arranged in a bypass line which branches off the second gas line upstream of the second valve stage and feeds back into the second gas line downstream of the second valve stage.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a first embodiment of a tank venting device according to the present invention;

FIG. 2 is a schematic illustration of a second embodiment of a tank venting device according to the present invention;

FIG. 3 is a schematic illustration of a third embodiment of a tank venting device according to the present invention;

FIG. 4 is a schematic illustration of a fourth embodiment of a tank venting device according to the present invention;

FIG. 5 is a schematic illustration of a fifth embodiment of a tank venting device according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

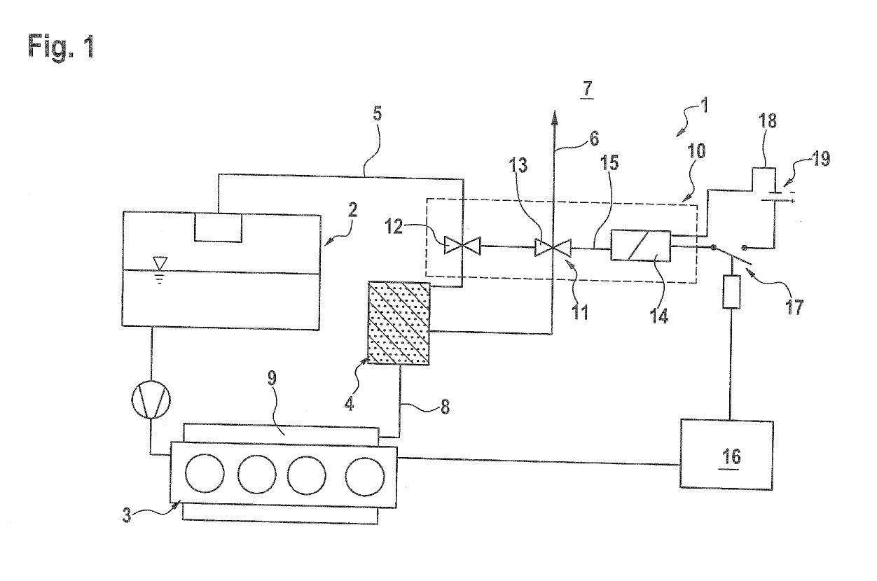

Turning now to the drawing, and in particular to FIG. 1, there is shown a schematic illustration of a first embodiment of a tank venting device according to the present invention, generally designated by reference numeral 1, for venting a fuel tank 2 of a plug-in electric drive motor vehicle (not shown) which is operated by an electric motor (not shown) and includes an internal combustion engine 3 as auxiliary motor for charging a vehicle battery 19.

The tank venting device 1 includes an activated carbon filter 4. A first gas line 5 connects the activated carbon filter 4 with the interior of the fuel tank 2. A second gas line 6 connects the activated carbon filter 4 with the environment or atmosphere 7, and a third gas line 8 connects the activated carbon filter 4 with an intake tract 9 of the internal combustion engine 3. The tank venting device 1 further includes a valve unit 10 which is indicated in FIG. 1 by a broken line. The valve unit 10 includes a two-stage solenoid valve 11 which has a first valve stage 12 arranged in the first gas line 5, and a second valve stage 13 arrange in the second gas line 6. An inlet of the first valve stage 12 is in communication with the interior of the fuel tank 2, and an outlet of the first valve stage 12 is in communication with the interior of the activated carbon filter 4. The second valve stage 13 has an inlet in communication with the interior of the activated carbon filter 4 and an outlet in communication with the environment or atmosphere 7.

The solenoid valve 11 includes a single solenoid 14 for operating the two valve stages 12, 13. The solenoid 14 has an armature 15 which is rigidly connected with a shared valve member (not shown) of both valve stages 12, 13. Operation of the solenoid valve 11 is controlled by a motor control device 16 of the internal combustion engine 3. For this purpose, a switch 17, which is activated by the motor control device 16, is provided in an electric circuit 18 between the vehicle battery 19 of the motor vehicle and an excitation coil of the electric motor 14, with the switch 17 being closed or opened to feed current to the excitation coil or to cut the current feed to the excitation coil, respectively.

The solenoid valve 11 may be constructed in the form of a shut-off valve which can be switched over only between a closed position and an open position, with the armature 15 of the solenoid valve 14 respectively occupying one of two possible end positions. As an alternative, the solenoid valve 11 may also be configured as a proportionally controlled valve in which the movement path of the armature 15 of the solenoid 14 and thus the respective opening cross section of both valve stages 12, 13 of the solenoid valve 11 depends on the current intensity of current flowing through the excitation coil.

The solenoid valve 11 may selectively configured in such a way as to open, when no current flows through the excitation coil, and to close, when current flows through the excitation coil, or vice versa, i.e. the solenoid valve 11 opens when current flows through the excitation coil, and closes, when no current flows through the excitation coil. The solenoid valve 11 may also be configured in such a way as to open when current is supplied to the excitation coil and to remain open, when the current supply is interrupted, until the current supply is reestablished. In the event a proportionally controlled solenoid valve 11 is used, the solenoid valve 11 remains in partially open position, when the current supply is cut, so that both valve stages 12, 13 have each a defined opening cross section. The solenoid valve 11 may also be configured to close, when current is fed to the excitation coil and remains in the closed position after the current supply is interrupted. Likewise a proportionally controlled valve as solenoid valve 11 may remain in a partially closed position, when the current supply is interrupted, with both valve stages 12, 13 also having defined opening cross sections.

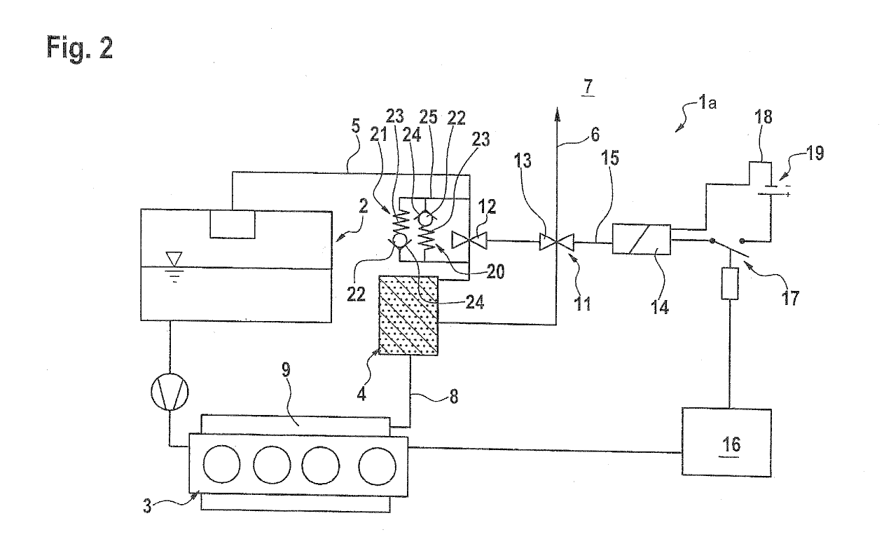

Referring now to FIG. 2, there is shown a schematic illustration of a second embodiment of a tank venting device according to the present invention, generally designated by reference numeral 1a. Parts corresponding with those in FIG. 1 are denoted by identical reference numerals and not explained again. The description below will center on the differences between the embodiments. In this embodiment, provision is made for the presence of at least two overflow valves 20, 21. Each of the overflow valves 20, 21 includes a valve member 22 which is urged by a valve spring 23 against a valve seat 24. The overflow valve 20 operates hereby as overpressure protection valve whereas the overflow valve 21 operates as low pressure protection valve. The overpressure protection valve 21 opens spontaneously, when the pressure on the valve-spring-distal side of the valve member 22 exceeds an opening pressure defined by the spring force, and closes spontaneously, when the pressure drops again below the opening pressure. The low pressure protection valve 21 opens spontaneously, when a low pressure is applied on the valve-spring-proximal side of the valve member 22 to lift the valve member 22 off the valve seat 24 in opposition to the force applied by the valve spring 23, and closes spontaneously, when the force of the valve spring 23 again exceeds the force applied by the low pressure upon the valve member 22.

The tank venting device 1a includes only a single pair of overflow valves 20, 21 in the form of an overpressure protection valve 20 and a low pressure protection valve 21. Both overflow valves 20, 21 are arranged in parallel in a bypass line 25 which branches off the first gas line 5 upstream of the first valve stage 12 and feeds back again into the first gas line 5 downstream of the first valve stage 12.

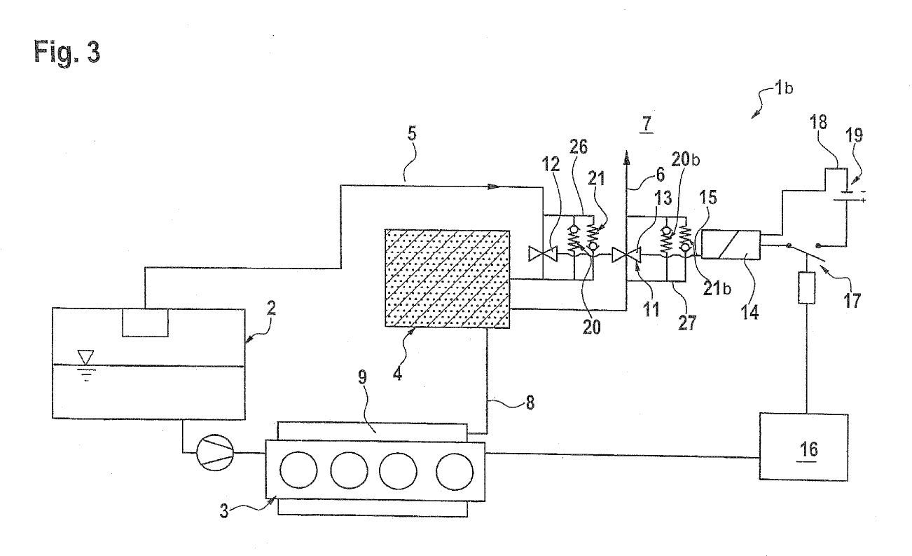

FIG. 3 shows a schematic illustration of a third embodiment of a tank venting device according to the present invention, generally designated by reference numeral 1b. Parts corresponding with those in FIGS. 1 and 2 are denoted by identical reference numerals and not explained again. The description below will again center on the differences between the embodiments. In this embodiment, provision is made for two pairs of overflow valves 20, 21 and 20b, 21b.

In general, overflow valves are always arranged in pairs, with one overflow valve of each pair operating as overpressure protection valve and the other overflow valve of each pair operating as low pressure protection valve.

In the tank venting device 1b of FIG. 3, the pair of overflow valves 20, 21 is arranged in a same manner as described with reference to the tank venting device 1a of FIG. 2, with a bypass line 26 which branches off the first gas line 5 upstream of the first valve stage 12 and feeds back into the first gas line 5 downstream of the first valve stage 12. The other pair of overflow valves 20b, 21b is arranged in a bypass line 27 which branches off the second gas line 6 upstream of the second valve stage 13 and feeds back into the second gas line 6 downstream of the second valve stage 13.

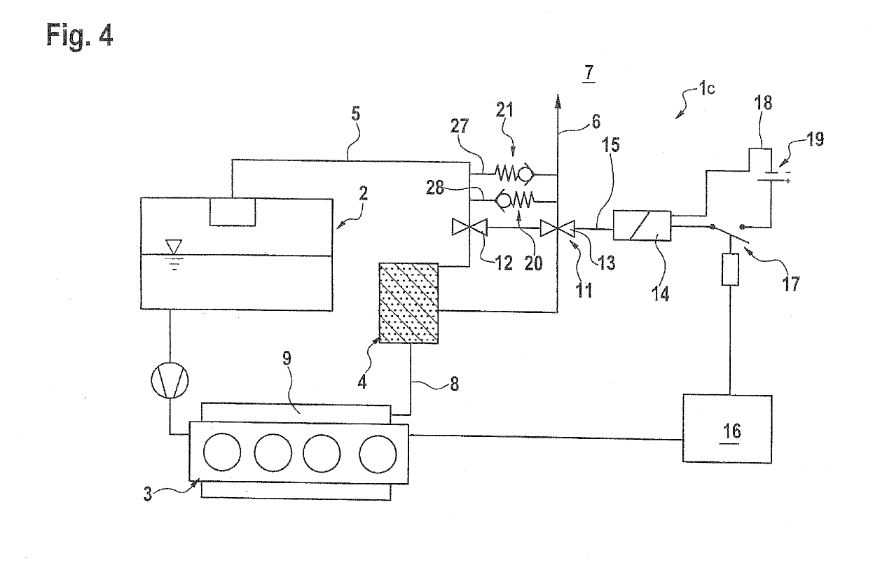

FIG. 4 shows a schematic illustration of a fourth embodiment of a tank venting device according to the present invention, generally designated by reference numeral 1c. Parts corresponding with those in FIGS. 1 to 3 are denoted by identical reference numerals and not explained again. The description below will again center on the differences between the embodiments. In this embodiment, provision is made for a pair of overflow valves 20, 21 in the form of an overpressure protection valve 20 and a low pressure protection valve 21 which are arranged in parallel in two bypass lines 28, 29 which branch off the first gas line 5 upstream of the first valve stage 12 and feed into the second gas line 6 downstream of the second valve stage 13.

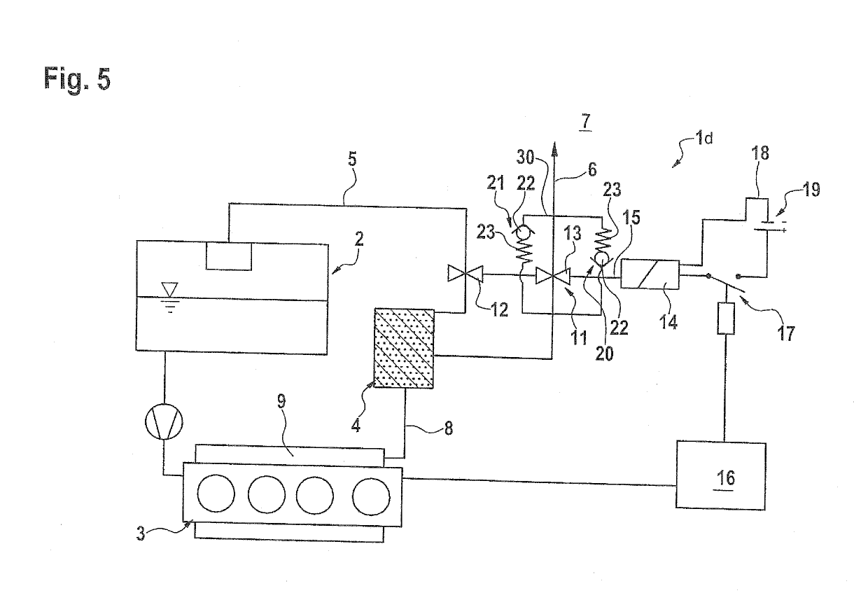

FIG. 5 shows a schematic illustration of a fifth embodiment of a tank venting device according to the present invention, generally designated by reference numeral 1d. Parts corresponding with those in FIGS. 1 to 4 are denoted by identical reference numerals and not explained again. The description below will again center on the differences between the embodiments. In this embodiment, provision is made again for the presence of only one pair of overflow valves 20, 21 in the form of an overpressure protection valve 20 and a low pressure protection valve 21 which are arranged in parallel in two bypass lines 30, 31 which branch off the second gas line 6 upstream of the second valve stage 13 and feed back into the second gas line 6 downstream of the second valve stage 13.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A tank venting device for a fuel tank of a motor vehicle, comprising:
an activated carbon filter connected to a fuel tank via a first gas line and connected to the atmosphere or ambient environment via a second gas line; and
a valve unit including a single two-stage solenoid valve which controls a gas flow through the first and second gas lines.

2. The tank venting device of claim 1, wherein the solenoid valve includes a single solenoid to actuate a first valve stage in the first gas line and a second valve stage in the second gas line.

3. The tank venting device of claim 2, wherein the solenoid has an armature which is fixedly connected with a valve member of the first valve stage and with a valve member of the second valve stage.

4. The tank venting device of claim 2, wherein the solenoid valve is constructed with a proportional control in which an opening cross section of the first and second valve stages is proportional to a current intensity of an excitation current of the solenoid.

5. The tank venting device of claim 2 wherein the solenoid valve is a shut-off valve, with the first and second valve stages being switchable only between an open position and a closed position.

6. The tank venting device of claim 2, wherein the first and second valve stages of the solenoid valve open, when current is supplied to the solenoid and close when a supply of current is interrupted, or vice versa.

7. The tank venting device of claim 2, wherein the first and second valve stages of the solenoid valve open, when current is supplied to the solenoid and remain open when a supply of current is interrupted until the supply of current to the solenoid is established again.

8. The tank venting device of claim 1, further comprising at least two overflow valves switched in parallel, with one of the overflow valves constructed in the form of an overpressure protection valve and with the other one of the overflow valves constructed in the form of an low pressure protection valve.

9. The tank venting device of claim 8, wherein the two overflow valves are arranged in a bypass line which branches off the first gas line upstream of the first valve stage and feeds into the second gas line downstream of the second valve stage.

10. The tank venting device of claim 8, wherein the two overflow valves are arranged in a bypass line which branches off the first gas line upstream of the first valve stage and feeds back into the first gas line downstream of the first valve stage.

11. The tank venting device of claim 8, wherein the two overflow valves are arranged in a bypass line which branches off the second gas line upstream of the second valve stage and feeds back into the second gas line downstream of the second valve stage.
